(19) United States
(12) Patent Application Publication
(10) Pub. No.: US 2025/0068964 A1
(43) Pub. Date: Feb. 27, 2025

(54) MACHINE LEARNING BASED SYSTEM AND METHOD FOR OPTIMIZING FEATURES OF TRAINING DATASETS OF PRODUCTS

(71) Applicant: ParallelDots, Inc., Seattle, WA (US)

(72) Inventors: Muktabh Mayank Srivastava, Gorakhpur (IN); Angam Parashar, Gwalior (IN); Ankit Narayan Singh, Rishikesh (IN)

(21) Appl. No.: 18/455,673

(22) Filed: Aug. 25, 2023

(51) Int. Cl. G06N 20/00

(52) U.S. Cl. CPC G06N 20/00

(57) ABSTRACT

A machine learning based system for optimizing features of training datasets of products is disclosed. The machine learning based system is configured to: (a) obtain data associated with first images of each product of first products, (b) analyze second images of each product of second products, one product at a time, using a machine learning model, (c) cluster the second analyzed images of each product of the second products, one product at a time, using a clustering model, (d) create one or more sets to obtain the clustered second analyzed images corresponding to each product of the second products, (e) validate each set of the one or more sets created for the second analyzed images of each product to classify the one or more sets, and (f) utilize the clustered second analyzed images for the training datasets for optimizing the features of the training datasets.

### FIELD OF INVENTION

Embodiments of the present disclosure relate to machine learning based systems, and more particularly relate to a machine learning based system and method for optimizing one or more features of training datasets of one or more products.

### BACKGROUND

Generally, performance of image recognition applications heavily relies on precision of training datasets used. Conventionally, human annotators are responsible for annotating or labeling the training data, resulting in higher quality of the training data. However, manual labelling of the training data is a time-consuming process. In the context of retail product recognition, there are instances where two or more products have similar packaging, leading to confusion among the human annotators during the labelling process.

Making accurate annotations for many instances is challenging due to multiple similar-looking packaging available in a market. Consequently, the human annotators encounter difficulties in accurately labelling the training data for products with similar appearances.

Therefore, there is a need for an improved machine learning based system and method for optimizing one or more features of training datasets of one or more products, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine learning based system for optimizing one or more features (i.e., enhancing quality) of training datasets of one or more products is disclosed. The machine learning based system includes one or more hardware processors and a memory unit. The memory unit is coupled to the one or more hardware processors. The memory unit comprises a set of program instructions in form of a plurality of subsystems, configured to be executed by the one or more hardware processors. The plurality of subsystems comprises a data obtaining subsystem, a data training subsystem, an image analyzing subsystem, an image clustering subsystem, a cluster validation subsystem, and a cluster utilizing subsystem.

The data obtaining subsystem is configured to obtain a plurality of data associated with first one or more images corresponding to each product of first one or more products.

The data training subsystem configured to train a machine learning model based on the plurality of data associated with the first one or more images corresponding to each product of the first one or more products.

The image analyzing subsystem is configured to analyze second one or more images corresponding to each product of second one or more products, one product at a time, using the machine learning model trained on the first one or more images corresponding to each product of the first one or more products.

The image clustering subsystem is configured to cluster the second one or more analyzed images corresponding to each product of the second one or more products, one product at a time, in one or more sets, using a clustering model. The image clustering subsystem is further configured to create one or more sets to obtain the clustered second one or more analyzed images corresponding to each product of the second one or more products. Each set of the one or more sets comprises at least one second analyzed image corresponding to each product of the second one or more products. The one or more sets of the second one or more analyzed images corresponding to each product of the second one or more products, comprises at least one of: a first set of the second one or more analyzed images corresponding to a first product, a second set of the second one or more analyzed images corresponding to a second product, and an nth set of the second one or more analyzed images corresponding to an nth product. The first product, the second product, and the nth product, are different products.

When the second one or more analyzed images corresponding to each product of the second one or more products is clustered, the one or more sets is created for the second one or more products. The second one or more products comprises at least one of: (a) two or more analogical sub-products with analogical characteristics, (b) the two or more analogical sub-products with distinct characteristics, and (c) two or more distinct sub-products with distinct characteristics.

The cluster validation subsystem is configured to validate each set of the one or more sets created for the second one or more analyzed images corresponding to each product of the second one or more products to classify the one or more sets. The one or more sets is classified as at least one of: the one or more sets created for the second one or more products that comprises at least one of: the two or more analogical sub-products with the analogical characteristics, the two or more analogical sub-products with the distinct characteristics, and the two or more distinct sub-products with the distinct characteristics.

The cluster utilizing subsystem is configured to utilize the clustered second one or more analyzed images for the training datasets for optimizing the one or more features of the training datasets, upon validation of each set of the one or more sets of the second one or more analyzed images corresponding to each product of the second one or more products.

In an embodiment, in training the machine learning model based on the plurality of data associated with the first one or more images corresponding to each product of the first one or more products, the data training subsystem is configured to: (a) receive the plurality of data associated with the first one or more images corresponding to each product of the first one or more products, from the data obtaining subsystem, (b) provide a plurality of labels related to the first one or more images to the machine learning model, wherein the plurality of labels comprises of names of the first one or more products, and (c) train the machine learning model by correlating the first one or more images corresponding to each product of the first one or more products, with the plurality of labels related to the first one or more images. The machine learning model is a supervised machine learning model.

In another embodiment, in analyzing, using the trained machine learning model, the second one or more images corresponding to each product of the second one or more products, the image analyzing subsystem is configured to: (a) obtain the second one or more images corresponding to each product of the second one or more products, at the trained machine learning model, (b) compare the second one or more images corresponding to each product of the second one or more products, one product at a time, using one or more vectors from the trained machine learning model, and (c) analyze the second one or more images corresponding to each product of the second one or more products, one product at a time, based on the comparison of the second one or more images corresponding to each product of the second one or more products, using the trained machine learning model.

In yet another embodiment, the trained machine learning model is configured to output the one or more vectors comprising one or more numerical values associated with the second one or more analyzed images corresponding to each product of the second one or more products.

In yet another embodiment, in clustering, using the clustering model, the second one or more analyzed images in the one or more sets, the image clustering subsystem is configured to: (a) obtain the second one or more analyzed images corresponding to each product of the second one or more products, from the image analyzing subsystem, (b) compare each of the second one or more analyzed images with the second one or more analyzed images corresponding to each product of the second one or more products, one product at a time, and (c) cluster the second one or more analyzed images corresponding to each product of the second one or more products in the one or more sets, based on the comparison of each of the second one or more analyzed images with the second one or more analyzed images corresponding to each product of the second one or more products, one product at the time.

The one or more sets is created for the second one or more analyzed images corresponding to each product of the second one or more products. The compared second two or more analyzed images are corresponding to an analogical sub-product of the second one or more products. Each set of the one or more sets is a sub-product cluster created for the second one or more analyzed images corresponding to the second one or more products. The one or more sets is classified as at least one of: the one or more sets created for the second one or more products that comprises at least one of: the two or more analogical sub-products with the analogical characteristics, the two or more analogical sub-products with the distinct characteristics, and the two or more distinct sub-products with the distinct characteristics.

In yet another embodiment, the clustering model is a density-based spatial clustering of applications with noise (DBSCAN) model for clustering the second one or more analyzed images into the one or more sets.

In yet another embodiment, further comprising a product grouping subsystem configured to group one or more sub-product clusters created for the second one or more analyzed images corresponding to the one or more products when second two or more products of second one or more sub-products are analogous.

In yet another embodiment, upon grouping the one or more sub-product clusters, the product grouping subsystem is configured to perform one or more checks at cluster level to determine errors in data associated with the second one or more analyzed images corresponding to the second one or more products. The performing of the one or more checks comprises at least one of: (a) checking whether a first sub-product cluster needs to be left alone when the first sub-product cluster is created during analyzing of the second one or more images corresponding to each product of the second one or more products, the first sub-product cluster corresponds to, (b) checking whether the second one or more analyzed images corresponding to the first product of the second one or more products, in the first sub-product cluster, is merged with the second one or more analyzed images corresponding to the second product of the second one or more products when a correspondence between the first product and the second product is determined, and (c) checking whether a second sub-product cluster created is at least one of: not a part of the second one or more products, and not a part of products other than the second one or more products

In one aspect, a machine learning based method for optimizing one or more features of training datasets of one or more products is disclosed. The machine learning based method includes obtaining, by one or more hardware processors, a plurality of data associated with first one or more images corresponding to each product of first one or more products.

The machine learning based method further includes training, by the one or more hardware processors, a machine learning model based on the plurality of data associated with the first one or more images corresponding to each product of the first one or more products.

The machine learning based method further includes analyzing, by the one or more hardware processors, second one or more images corresponding to each product of second one or more products, one product at a time, using the machine learning model trained on the first one or more images corresponding to each product of the first one or more products.

The machine learning based method further includes clustering, by the one or more hardware processors, the second one or more analyzed images corresponding to each product of the second one or more products, one product at a time, using a clustering model.

The machine learning based method further includes creating, by the one or more hardware processors, one or more sets to obtain the clustered second one or more analyzed images corresponding to each product of the second one or more products. Each set of the one or more sets comprises at least one second analyzed image corresponding to each product of the second one or more products.

The one or more sets of the second one or more analyzed images corresponding to each product of the second one or more products, comprises at least one of: a first set of the second one or more analyzed images corresponding to a first product, a second set of the second one or more analyzed images corresponding to a second product, and an nth set of the second one or more analyzed images corresponding to an nth product. The first product, second product, and the nth product are different products. When the second one or more analyzed images corresponding to each product of the second one or more products is clustered, the one or more sets is created for the second one or more products. The second one or more products comprises at least one of: (a) two or more analogical sub-products with analogical characteristics, (b) the two or more analogical sub-products with distinct characteristics, and (c) two or more distinct sub-products with distinct characteristics.

The machine learning based method further includes validating, by the one or more hardware processors, each set of the one or more sets created for the second one or more analyzed images corresponding to each product of the second one or more products to classify the one or more sets. The one or more sets is classified as at least one of: the one or more sets created for the second one or more products that comprises at least one of: the two or more analogical sub-products with the analogical characteristics, the two or more analogical sub-products with the distinct characteristics, and the two or more distinct sub-products with the distinct characteristics.

The machine learning based method further includes utilizing, by the one or more hardware processors, the clustered second one or more analyzed images for the training datasets for optimizing the one or more features of the training datasets, upon validation of each set of the one or more sets of the second one or more analyzed images corresponding to each product of the second one or more products.

In an embodiment, training the machine learning model based on the plurality of data associated with the first one or more images corresponding to each product of the first one or more products, comprises: (a) receiving, by the one or more hardware processors, the plurality of data associated with the first one or more images corresponding to each product of the first one or more products, (b) providing, by the one or more hardware processors, a plurality of labels related to the first one or more images to the machine learning model, wherein the plurality of labels comprises of names of the first one or more products, and (c) training, by the one or more hardware processors, the machine learning model by correlating the first one or more images of each product of the first one or more products, with the plurality of labels related to the first one or more images. The machine learning model is a supervised machine learning model.

In another embodiment, analyzing, using the trained machine learning model, the second one or more images corresponding to each product of the second one or more products, comprises: (a) obtaining, by the one or more hardware processors, the second one or more images corresponding to each product of the second one or more products, at the trained machine learning model, (b) comparing, by the one or more hardware processors, the second one or more images corresponding to each product of the second one or more products, one product at a time, using one or more vectors from the trained machine learning model, and (c) analyzing, by the one or more hardware processors, the second one or more images corresponding to each product of the second one or more products, one product at a time, based on the comparison of the second one or more images corresponding to each product of the second one or more products, using the trained machine learning model.

In yet another embodiment, the trained machine learning model is configured to output the one or more vectors comprising one or more numerical values associated with the second one or more analyzed images corresponding to each product of the second one or more products.

In yet another embodiment, clustering, using the clustering model, the second one or more analyzed images in the one or more sets, comprises: (a) obtaining, by the one or more hardware processors, the second one or more analyzed images corresponding to each product of the second one or more products, (b) comparing, by the one or more hardware processors, each of the second one or more analyzed images with the second one or more analyzed images corresponding to each product of the second one or more products, one product at a time, and (c) clustering, by the one or more hardware processors, the second one or more analyzed images corresponding to each product of the second one or more products in the one or more sets, based on the comparison of each of the second one or more analyzed images with the second one or more analyzed images corresponding to each product of the second one or more products, one product at a time.

The one or more sets is created for the second one or more analyzed images corresponding to each product of the second one or more products. The compared second two or more analyzed images are corresponding to an analogical sub-product of the second one or more products. Each set of the one or more sets is a sub-product created for the second one or more analyzed images corresponding to the second one or more products. The one or more sets is classified as at least one of: the one or more sets created for the second one or more products that comprises at least one of: the two or more analogical sub-products with the analogical characteristics, the two or more analogical sub-products with the distinct characteristics, and the two or more distinct sub-products with the distinct characteristics.

In yet another embodiment, the clustering model is a density-based spatial clustering of applications with noise (DBSCAN) model for clustering the second one or more analyzed images into the one or more sets.

In yet another embodiment, the machine learning based method further includes grouping, by the one or more hardware processors, one or more sub-product clusters created for the second one or more analyzed images corresponding to the second one or more products when second two or more products of second one or more sub-products are analogous.

In yet another embodiment, upon grouping the one or more sub-product clusters, the machine learning based method further includes performing, by the one or more hardware processors, one or more checks at cluster level to determine errors in data associated with the second one or more analyzed images corresponding to the second one or more products. The performing of the one or more checks comprises at least one of: (a) checking, by the one or more hardware processors, whether a first sub-product cluster needs to be left alone when the first sub-product cluster is created during analyzing of the second one or more images corresponding to each product of the second one or more products, the first sub-product cluster corresponds to, (b) checking, by the one or more hardware processors, whether the second one or more analyzed images corresponding to the first product of the second one or more products, in the first sub-product cluster, is merged with the second one or more analyzed images corresponding to the second product of the second one or more products when a correspondence between the first product and the second product is determined, and (c) checking, by the one or more hardware processors, whether a second sub-product cluster created is at least one of: not a part of the second one or more products, and not a part of products other than the second one or more products.

In another aspect, a non-transitory computer-readable storage medium having instructions stored therein that when executed by one or more hardware processors, cause the one or more hardware processors to execute operations of: (a) obtaining a plurality of data associated with first one or more images corresponding to each product of the first one or more products, (b) training a machine learning model based on the plurality of data associated with the first one or more images corresponding to each product of the first one or more products, (c) analyzing second one or more images corresponding to each product of second one or more products, one product at a time, using the machine learning model trained on the first one or more images corresponding to each product of the first one or more products, (d) clustering the second one or more analyzed images corresponding to each product of the second one or more products, one product at a time, using a clustering model, (e) creating one or more sets to obtain the clustered second one or more analyzed images corresponding to each product of the second one or more products, and (f) validating each set of the one or more sets created for the second one or more analyzed images corresponding to each product of the second one or more products to classify the one or more sets, and (g) utilizing the clustered second one or more analyzed images for the training datasets for optimizing the one or more features of the training datasets, upon validation of each set of the one or more sets of the second one or more analyzed images corresponding to each product of the second one or more products.

Each set of the one or more sets comprises at least one second analyzed image corresponding to each product of the second one or more products. The one or more sets of the second one or more analyzed images corresponding to each product of the second one or more products, comprises at least one of: a first set of the second one or more analyzed images corresponding to a first product, a second set of the second one or more analyzed images corresponding to a second product, and an nth set of the second one or more analyzed images corresponding to an nth product.

The first product, the second product, and nth product are different products. When the second one or more analyzed images corresponding to each product of the second one or more products is clustered, the one or more sets is created for the second one or more products. The second one or more products comprises at least one of: (a) two or more analogical sub-products with analogical characteristics, (b) the two or more analogical sub-products with distinct characteristics, and (c) two or more distinct sub-products with distinct characteristics.

The one or more sets is classified as at least one of: the one or more sets created for the second one or more products that comprises at least one of: the two or more analogical sub-products with the analogical characteristics, the two or more analogical sub-products with the distinct characteristics, and the two or more distinct sub-products with the distinct characteristics.

In an embodiment, training the machine learning model based on the plurality of data associated with the first one or more images corresponding to each product of the first one or more products, comprises: (a) receiving the plurality of data associated with the first one or more images corresponding to each product of the first one or more products, (b) providing a plurality of labels related to the first one or more images to the machine learning model, wherein the plurality of labels comprises of names of the first one or more products, and (c) training the machine learning model by correlating the first one or more images of each product of the first one or more products, with the plurality of labels related to the first one or more images The machine learning model is a supervised machine learning model.

In another embodiment, analyzing, using the trained machine learning model, the second one or more images corresponding to each product of the second one or more products, comprises: (a) obtaining the second one or more images corresponding to each product of the second one or more products, at the trained machine learning model, (b) comparing the second one or more images corresponding to each product of the second one or more products, one product at a time, using one or more vectors from the trained machine learning model, and (c) analyzing the second one or more images corresponding to each product of the second one or more products, one product at a time, based on the comparison of the second one or more images corresponding to each product of the second one or more products, using the trained machine learning model.

In yet another embodiment, the trained machine learning model is configured to output the one or more vectors comprising one or more numerical values associated with the second one or more analyzed images corresponding to each product of the second one or more products.

In yet another embodiment, clustering, using the clustering model, the second one or more analyzed images in the one or more sets, comprises: (a) obtaining the second one or more analyzed images corresponding to each product of the second one or more products, (b) comparing each of the second one or more analyzed images with the second one or more analyzed images corresponding to each product of the second one or more products, one product at a time, and (c) clustering the second one or more analyzed images corresponding to each product of the second one or more products in the one or more sets, based on the comparison of each of the second one or more analyzed images with the second one or more analyzed images corresponding to each product of the second one or more products, one product at a time.

The one or more sets is created for the second one or more analyzed images corresponding to each product of the second one or more products. The compared second two or more analyzed images are corresponding to an analogical sub-product of the second one or more products. Each set of the one or more sets is a sub-product created for the second one or more analyzed images corresponding to the second one or more products. The one or more sets is classified as at least one of: the one or more sets created for the second one or more products that comprises at least one of the two or more analogical sub-products with the analogical characteristics, the two or more analogical sub-products with the distinct characteristics, and the two or more distinct sub-products with the distinct characteristics.

In yet another embodiment, the clustering model is a density-based spatial clustering of applications with noise (DBSCAN) model for clustering the second one or more analyzed images into the one or more sets.

In yet another embodiment, the non-transitory computer-readable storage medium having instruction that execute further operation of grouping one or more sub-product clusters created for the second one or more analyzed images corresponding to the second one or more products when second two or more products of second one or more sub-products are analogous.

In yet another embodiment, upon grouping the one or more sub-product clusters, the non-transitory computer-readable storage medium having instruction that execute further operation of performing one or more checks at cluster level to determine errors in data associated with the second one or more analyzed images corresponding to the second one or more products. The performing of the one or more checks comprises at least one of: (a) checking whether a first sub-product cluster needs to be left alone when the first sub-product cluster is created during analyzing of the second one or more images corresponding to each product of the second one or more products, the first sub-product cluster corresponds to, (b) checking whether the second one or more analyzed images corresponding to the first product of the second one or more products, in the first sub-product cluster, is merged with the second one or more analyzed images corresponding to the second product of the second one or more products when a correspondence between the first product and the second product is determined, and (c) checking whether a second sub-product cluster created is at least one of: not a part of the second one or more products, and not a part of products other than the second one or more products.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based system for optimizing one or more features of training datasets of one or more products, in accordance with an embodiment of the present disclosure;

FIG. 2 is a detailed view of the machine learning based system, in accordance with another embodiment of the present disclosure; and

FIG. 3 is a flow chart illustrating a machine learning based method for optimizing the one or more features of training datasets of one or more products, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof. are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

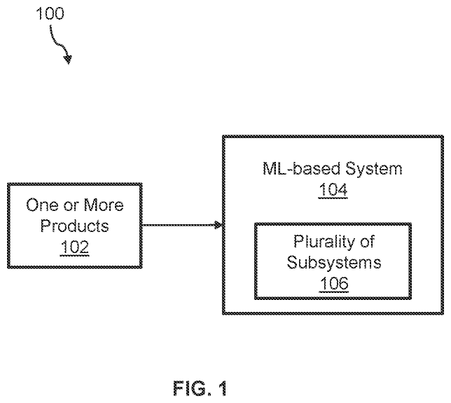

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

According to an embodiment, the terms “storage unit” and “database” are used interchangeably throughout the below description.

FIG. 1 is a block diagram 100 illustrating a computing environment with a machine learning based system 104 for optimizing one or more features (i.e., enhancing quality) of training datasets of one or more products 102, in accordance with an embodiment of the present disclosure. The machine learning based system 104 is configured to obtain a plurality of data associated with first one or more images corresponding to each product of first one or more products. The machine learning based system 104 is further configured to train a machine learning model based on the plurality of data associated with the first one or more images corresponding to each product of the first one or more products. The machine learning based system 104 is further configured to analyze second one or more images corresponding to each product of second one or more products, one product at a time, using the machine learning model trained on the first one or more images corresponding to each product of the first one or more products.

The machine learning based system 104 is further configured to cluster the second one or more analyzed images corresponding to each product of the second one or more products, one product at a time, using a clustering model. The machine learning based system 104 is further configured to create one or more sets to obtain the clustered second one or more analyzed images corresponding to each product of the second one or more products. In an embodiment, each set of the one or more sets includes at least one second analyzed image corresponding to each product of the second one or more products. In an embodiment, the one or more sets of the second one or more analyzed images corresponding to each product of the second one or more products, includes at least one of: (a) a first set of the second one or more analyzed images corresponding to a first product, (b) a second set of the second one or more analyzed images corresponding to a second product, and (c) an nth set of the second one or more analyzed images corresponding to an nth product. In an embodiment, the first product, the second product, and the nth product, are different products.

In an embodiment, when the second one or more analyzed images corresponding to each product of the second one or more products is clustered, the one or more sets is created for the second one or more products that comprises at least one of: two or more analogical sub-products with analogical characteristics. (b) the two or more analogical sub-products with distinct characteristics, and (c) two or more distinct sub-products with distinct characteristics.

The machine learning based system 104 is further configured to validate each set of the one or more sets created for the second one or more analyzed images corresponding to each product of the second one or more products to classify the one or more sets. In an embodiment, the one or more sets are classified as at least one of: (a) the one or more sets created for the second one or more products that comprises the two or more analogical sub-products with the analogical characteristics, (b) the one or more sets created for the second one or more products that comprises the two or more analogical sub-products with the distinct characteristics, and (c) the one or more sets created for the second one or more products that comprises the two or more distinct sub-products with the distinct characteristics. The machine learning based system 104 is further configured to utilize the clustered second one or more analyzed images for the training datasets for optimizing the one or more features (i.e., enhancing quality) of the training datasets, upon validation of each set of the one or more sets of the second one or more analyzed images corresponding to each product of the second one or more products.

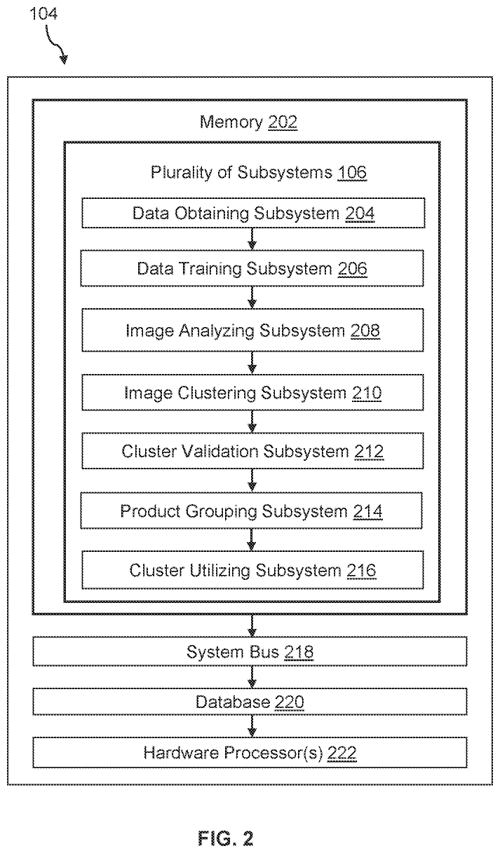

In an embodiment of the present disclosure, the machine learning based system 104 includes a plurality of subsystems 106. Details on the plurality of subsystems 106 have been elaborated in subsequent paragraphs of the present description with reference to FIG. 2.

FIG. 2 is a detailed view of the machine learning based system 104 for optimizing the one or more features of the training datasets of the one or more products 102, in accordance with an embodiment of the present disclosure. The machine learning based system 104 includes a memory unit 202, one or more hardware processors 222, and a storage unit (i.e., database) 220. The one or more hardware processors 222, the memory unit 202 and the storage unit 220 are communicatively coupled through a system bus 218 or any similar mechanism. The memory unit 202 includes the plurality of subsystems 106 in the form of programmable instructions executable by the one or more hardware processors 222.

The plurality of subsystems 106 includes a data obtaining subsystem 204, a data training subsystem 206, an image analyzing subsystem 208, an image clustering subsystem 210, a cluster validation subsystem 212, a product grouping subsystem 214, and a cluster utilizing subsystem 216.

The one or more hardware processors 222, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 222 may also include embedded controllers, such as generic or programmable logic devices or arrays, application specific integrated circuits, single-chip computers, and the like.

The memory unit 202 may be non-transitory volatile memory and non-volatile memory. The memory unit 202 may be coupled for communication with the one or more hardware processors 222, such as being a computer-readable storage medium. The one or more hardware processors 222 may execute machine-readable instructions and/or source code stored in the memory unit 202. A variety of machine-readable instructions may be stored in and accessed from the memory unit 202.

The memory unit 202 may include any suitable elements for storing data and machine-readable instructions, such as read only memory, random access memory, erasable programmable read only memory, electrically erasable programmable read only memory. a hard drive, a removable media drive for handling compact disks, digital video disks, diskettes, magnetic tape cartridges, memory cards, and the like. In the present embodiment, the memory unit 202 includes the plurality of subsystems 106 stored in the form of machine-readable instructions on any of the above-mentioned storage media and may be in communication with and executed by the one or more hardware processors 222.

The storage unit 220 may be a cloud storage, a Structured Query Language (SQL) data store or a location on a file system directly accessible by the plurality of subsystems 106.

The plurality of subsystems 106 includes the data obtaining subsystem 204 that is communicatively connected to the one or more hardware processors 222. The data obtaining subsystem 204 is configured to obtain the plurality of data associated with the first one or more images corresponding to each product of the first one or more products.

The plurality of subsystems 106 further includes the data training subsystem 206 that is communicatively connected to the one or more hardware processors 222. The data training subsystem 206 is configured to train the machine learning model based on the plurality of data associated with the first one or more images corresponding to each product of the first one or more products. For training the machine learning model, the data training subsystem 206 is configured to receive the plurality of data associated with the first one or more images corresponding to each product of the first one or more products, from the data obtaining subsystem 204.

The data training subsystem 206 is further configured to provide a plurality of labels related to the first one or more images to the machine learning model. In an embodiment, the plurality of labels includes names of the first one or more products. The data training subsystem 206 is further configured to train the machine learning model by correlating the first one or more images corresponding to each product of the first one or more products, with the plurality of labels related to the first one or more images. In an embodiment, the machine learning model is a supervised machine learning model.

The plurality of subsystems 106 further includes the image analyzing subsystem 208 that is communicatively connected to the one or more hardware processors 222. The image analyzing subsystem 208 is configured to analyze the second one or more images corresponding to each product of the second one or more products, one product at a time, using the machine learning model trained on the first one or more images corresponding to each product of the first one or more products. For analyzing the second one or more images corresponding to each product of the second one or more products, the image analyzing subsystem 208 is configured to obtain the second one or more images corresponding to each product of the second one or more products, at the trained machine learning model.

The image analyzing subsystem 208 is further configured to compare the second one or more images corresponding to each product of the second one or more products, one product at a time, using one or more vectors from the trained machine learning model. The image analyzing subsystem 208 is further configured to analyze the second one or more images corresponding to each product of the second one or more products, one product at a time, based on the comparison of the second one or more images corresponding to each product of the second one or more products using the trained machine learning model. In an embodiment, the trained machine learning model is configured to output the one or more vectors including one or more numerical values associated with the second one or more analyzed images corresponding to each product of the second one or more products. In an embodiment, the one or more vectors including one or more numerical values, is used to compare the second one or more analyzed images corresponding to each product of the second one or more products.

The plurality of subsystems 106 further includes the image clustering subsystem 210 that is communicatively connected to the one or more hardware processors 222. The image clustering subsystem 210 is configured to cluster the second one or more analyzed images corresponding to each product of the second one or more products, one product at a time, using the clustering model. The image clustering subsystem 210 is further configured to create the one or more sets to obtain the clustered second one or more analyzed images corresponding to each product of the second one or more products. In an embodiment, the clustering model is a density-based spatial clustering of applications with noise (DBSCAN) model for clustering the second one or more analyzed images into the one or more sets. In an embodiment, each set of the one or more sets includes at least one second analyzed image corresponding to each product of the second one or more products.

In an embodiment, the one or more sets of the second one or more analyzed images corresponding to each product of the second one or more products, includes at least one of: the first set of the second one or more analyzed images corresponding to the first product, the second set of the second one or more analyzed images corresponding to the second product, and so on (e.g., the nth set of the second one or more analyzed images corresponding to the nth product). In an embodiment, the first product, the second product, and the nth product, are different products.

In an embodiment, when the second one or more analyzed images corresponding to each product of the second one or more products is clustered, at least one of: (a) the one or more sets (e.g., the first set of the one or more sets) is created for the second one or more products that comprises the two or more analogical sub-products with the analogical characteristics, (b) the one or more sets (e.g., the second set of the one or more sets) is created for the second one or more products that comprises the two or more analogical sub-products with the distinct characteristics, due to confusion between the two or more analogical sub-products, and (c) the one or more sets (e.g., the nth set of the one or more sets) is created for the second one or more products that comprises the two or more distinct sub-products with the distinct characteristics, due to mistakes/errors among the two or more distinct sub-products.

For clustering the second one or more analyzed images in the one or more sets, the image clustering subsystem 210 is configured to obtain the second one or more analyzed images corresponding to each product of the second one or more products, from the image analyzing subsystem 208. The image clustering subsystem 210 is further configured to compare each of the second one or more analyzed images with the second one or more analyzed images corresponding to each product of the second one or more products, one product at a time. The image clustering subsystem 210 is further configured to cluster the second one or more analyzed images corresponding to each product of the second one or more products in the one or more sets, based on the comparison of each of the second one or more analyzed images with the second one or more analyzed images corresponding to each product of the second one or more products, one product at a time. In an embodiment, the compared second two or more analyzed images are corresponding to an analogical sub-product of the second one or more products.

For example, if the compared second two or more analyzed images are corresponding to the analogical sub-product (i.e., the first product) of the second one or more products, then the compared second two or more analyzed images corresponding to the first product are clustered in the first set of the one or more sets. In another example, if the compared second two or more analyzed images corresponding to the analogical sub-product (i.e., the second product) of the second one or more products but having different characteristics, then the compared second two or more analyzed images corresponding to the second product are clustered in the second set of the one or more sets. In another example, if the compared second two or more analyzed images corresponding to a different sub-product (i.e., the third product) of the second one or more products and also having different characteristics, then the compared second two or more analyzed images corresponding to the third product are clustered in the third set of the one or more sets. In an embodiment, each set of the one or more sets is considered to be a sub-product cluster created for the second one or more analyzed images corresponding to the second one or more products.

The plurality of subsystems 106 further includes the cluster validation subsystem 212 that is communicatively connected to the one or more hardware processors 222. The cluster validation subsystem 212 is configured to validate each set of the one or more sets of the second one or more analyzed images corresponding to each product of the second one or more products to classify the one or more sets. In an embodiment, the one or more sets are classified as at least one of: (a) the one or more sets (e.g., the first set of the one or more sets) created for the second one or more products that comprises the two or more analogical sub-products with the analogical characteristics, (b) the one or more sets (e.g., the second set of the one or more sets) created for the second one or more products that comprises the two or more analogical sub-products with the distinct characteristics, and (c) the one or more sets (e.g., the nth set of the one or more sets) created for the second one or more products that comprises the two or more distinct sub-products with the distinct characteristics.

The plurality of subsystems 106 further includes the product grouping subsystem 214 that is communicatively connected to the one or more hardware processors 222. The product grouping subsystem 214 is configured to group one or more sub-product clusters created for the second one or more analyzed images corresponding to the second one or more products when second two or more products of second one or more sub-products are analogous. Upon grouping the one or more sub-product clusters, the product grouping subsystem 214 is configured to perform one or more checks (e.g., manual checks) at cluster level to determine mistakes/errors in data associated with the second one or more analyzed images corresponding to each product of the second one or more products.

In an embodiment, performing of the one or more manual checks on the data associated with the second one or more analyzed images corresponding to each product of the second one or more products may be at least one of: (a) checking whether a first sub-product cluster needs to be left alone when the first sub-product cluster is created during analyzing of the second one or more images corresponding to each product of the second one or more products, the first sub-product cluster corresponds to, (b) checking whether the second one or more analyzed images corresponding to the first product of the second one or more products, in the first sub-product cluster, is merged with the second one or more analyzed images corresponding to the second product of the second one or more products when a correspondence between the first product and the second product is determined, and (c) checking whether a second sub-product cluster created is at least one of: not a part of the second one or more products, and not a part of products other than the second one or more products.

The plurality of subsystems 106 further includes the cluster utilizing subsystem 216 that is communicatively connected to the one or more hardware processors 222. The cluster utilizing subsystem 216 is configured to utilize the clustered second one or more analyzed images for the training datasets for optimizing the one or more features of the training datasets, upon validation of each set of the one or more sets of the second one or more analyzed images corresponding to each product of the second one or more products.

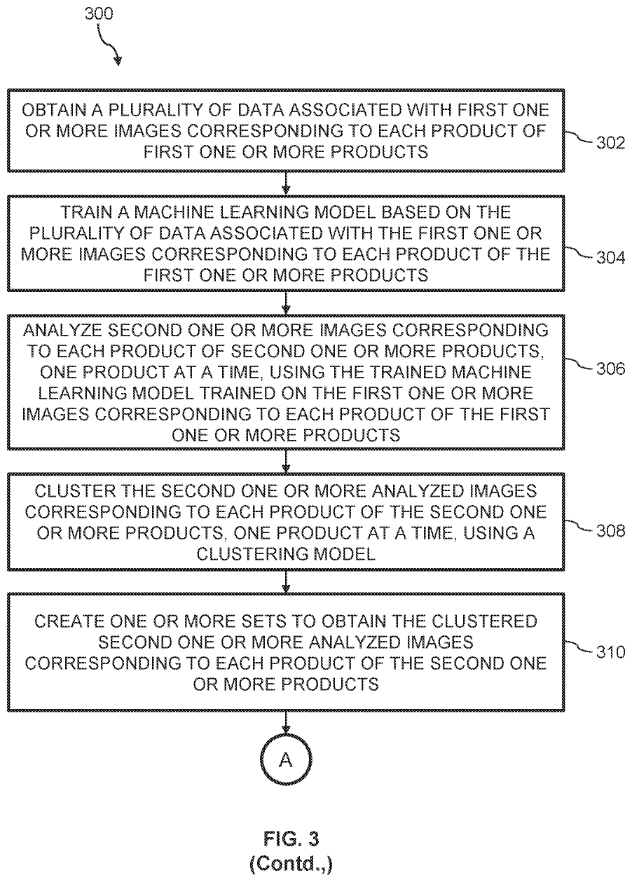

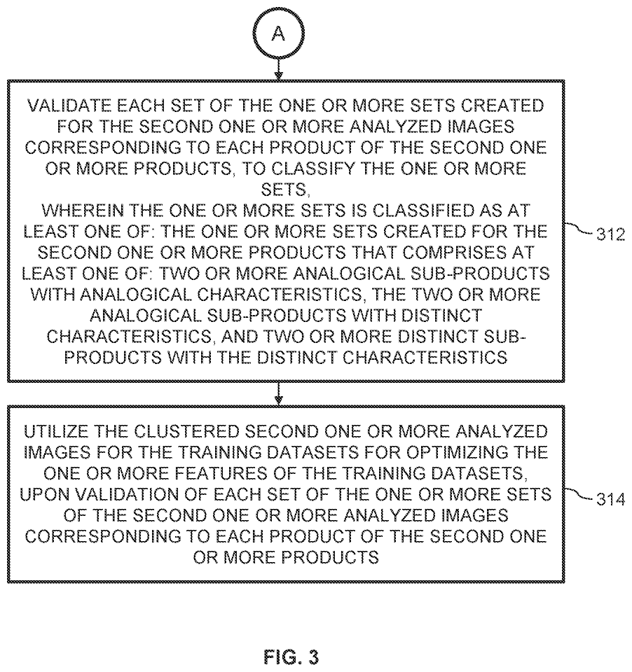

FIG. 3 is a flow chart illustrating a machine learning based method 300 for optimizing the one or more features of training datasets of one or more products, in accordance with an embodiment of the present disclosure.

At step 302, the plurality of data associated with the first one or more images corresponding to each product of the first one or more products, is obtained.

At step 304, the machine learning model is trained based on the plurality of data associated with the first one or more images corresponding to each product of the first one or more products

At step 306, the second one or more images corresponding to each product of second one or more products, one product at a time, is analyzed, using the machine learning model trained on the first one or more images of each product of the first one or more products

At step 308, the second one or more analyzed images corresponding to each product of the second one or more products, one product at a time, is clustered, using the clustering model.

At step 310, the one or more sets is created to obtain the clustered second one or more analyzed images corresponding to each product of the second one or more products. In an embodiment, each set of the one or more sets includes the at least second one analyzed image corresponding to each product of the second one or more products.

In an embodiment, the one or more sets of the second one or more analyzed images corresponding to each product of the second one or more products, includes at least one of: the first set of the second one or more analyzed images corresponding to the first product, the second set of the second one or more analyzed images corresponding to the second product, and the nth set of the second one or more analyzed images corresponding to the nth product. In an embodiment, the first product, the second product, and the nth product, are different products. In an embodiment, when the second one or more analyzed images corresponding to each product of the second one or more products is clustered, the one or more sets is created for the second one or more products that comprises at least one of: (a) the two or more analogical sub-products with the analogical characteristics, (b) the two or more analogical sub-products with the distinct characteristics, and (c) two or more distinct sub-products with the distinct characteristics.

At step 312, each set of the one or more sets created for the second one or more analyzed images corresponding to each product of the second one or more products, is validated for classifying the one or more sets. In an embodiment, the one or more sets is classified as at least one of: (a) the one or more sets (e.g., the first set of the one or more sets) is created for the second one or more products that comprises the two or more analogical sub-products with the analogical characteristics. (b) the one or more sets (e.g., the second set of the one or more sets) is created for the second one or more products that comprises the two or more analogical sub-products with the distinct characteristics, and (c) the one or more sets (e.g., the nth set of the one or more sets) is created for the second one or more products that comprises two or more distinct sub-products with the distinct characteristics.

At step 314, the clustered second one or more analyzed images is utilized for the training datasets for optimizing the one or more features of the training datasets, upon validation of each set of the one or more sets of the second one or more analyzed images corresponding to each product of the second one or more products.

The present invention has following advantages. The present invention helps to group similar looking package designs annotated for a product and visualization scheme so that the user can add/remove a new packaging style to the training dataset for the product, which optimizes the one or more features of the training dataset and leads to more accurate on the machine learning model.

The present invention further implements a deep learning model (i.e., a convolutional neural network or a transformer), trained on a large collection of the one or more images corresponding to the one or more products 102 (i.e., unrelated to the one or more products 102 for which the training dataset is being created), can be used to cluster different packaging styles annotated for a product. The user can easily add/remove different package clusters to a product's annotation once different packagings of a product are clustered, so that the training dataset is cleaned and better accuracy for the machine learning model is being trained.

The present invention further helps to avoid large turnaround time of training the machine learning model, to visualize the mistakes in real world and to change each mistaken annotation in the training dataset individually to achieve better accuracy of the machine learning model. The present invention further enables the user to validate the packaging clusters in a product annotation and to delete/reassign the packaging clusters if invalid. The present invention further provides a better view for the users (i.e., stakeholders) to understand what retail image recognition application is being trained on.

The present invention further helps clear out sub-products clusters among the second one or more images corresponding to each product of the second one or more products, which do not correspond to the product but are placed there due to confusion and/or mistakes. Normally, cleaning the data requires to validate each image of each product if it rightly classified, but in the present invention, the machine learning based system 104 needs to validate the clusters on images of each product.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the machine learning based system 104 either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The machine learning based system 104 herein comprises at least one processor or central processing unit (CPU). The CPUs are interconnected via system bus 218 to various devices such as a random-access memory (RAM), read-only memory (ROM). and an input/output (I/O) adapter. The I/O adapter can connect to peripheral devices, such as disk units and tape drives, or other program storage devices that are readable by the machine learning based system 104. The machine learning based system 104 can read the inventive instructions on the program storage devices and follow these instructions to execute the methodology of the embodiments herein.

The machine learning based system 104 further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A machine learning based system for optimizing one or more features of training datasets of one or more products, the machine learning based system comprising:
one or more hardware processors; and
a memory unit coupled to the one or more hardware processors, wherein the memory unit comprises a set of program instructions in form of a plurality of subsystems, configured to be executed by the one or more hardware processors, wherein the plurality of subsystems comprises:
a data obtaining subsystem configured to obtain a plurality of data associated with first one or more images corresponding to each product of first one or more products;
a data training subsystem configured to train a machine learning model based on the plurality of data associated with the first one or more images corresponding to each product of the first one or more products;
an image analyzing subsystem configured to analyze second one or more images corresponding to each product of second one or more products, one product at a time, using the machine learning model trained on the first one or more images corresponding to each product of the first one or more products;
an image clustering subsystem configured to:
cluster the second one or more analyzed images corresponding to each product of the second one or more products, one product at a time, using a clustering model; and
create one or more sets to obtain the clustered second one or more analyzed images corresponding to each product of the second one or more products,
wherein each set of the one or more sets comprises at least one second analyzed image corresponding to each product of the second one or more products,
wherein the one or more sets of the second one or more analyzed images corresponding to each product of the second one or more products, comprises at least one of: a first set of the second one or more analyzed images corresponding to a first product, a second set of the second one or more analyzed images corresponding to a second product, and an nth set of the second one or more analyzed images corresponding to an nth product,
wherein the first product, the second product, and the nth product are different products,
wherein when the second one or more analyzed images corresponding to each product of the second one or more products is clustered, the one or more sets is created for the second one or more products, and wherein the second one or more products comprises at least one of:
two or more analogical sub-products with analogical characteristics,
the two or more analogical sub-products with distinct characteristics, and
two or more distinct sub-products with distinct characteristics;
a cluster validation subsystem configured to validate each set of the one or more sets created for the second one or more analyzed images corresponding to each product of the second one or more products, to classify the one or more sets,
wherein the one or more sets is classified as at least one of:
the one or more sets created for the second one or more products, wherein the second one or more products comprises the two or more analogical sub-products with the analogical characteristics,
the one or more sets created for the second one or more products, wherein the second one or more products comprises the two or more analogical sub-products with the distinct characteristics, and
the one or more sets created for the second one or more products, wherein the second one or more products comprises the two or more distinct sub-products with the distinct characteristics; and
a cluster utilizing subsystem configured to utilize the clustered second one or more analyzed images for the training datasets for optimizing the one or more features of the training datasets, upon validation of each set of the one or more sets of the second one or more analyzed images corresponding to each product of the second one or more products.

2. The machine learning based system of claim 1, wherein in training the machine learning model based on the plurality of data associated with the first one or more images corresponding to each product of the first one or more products, the data training subsystem is configured to:
receive the plurality of data associated with the first one or more images corresponding to each product of the first one or more products, from the data obtaining subsystem;
provide a plurality of labels related to the first one or more images to the machine learning model, wherein the plurality of labels comprises of names of the first one or more products; and
train the machine learning model by correlating the first one or more images corresponding to each product of the first one or more products, with the plurality of labels related to the first one or more images, wherein the machine learning model is a supervised machine learning model.

3. The machine learning based system of claim 1, wherein in analyzing, using the trained machine learning model, the second one or more images corresponding to each product of the second one or more products, the image analyzing subsystem is configured to:
obtain the second one or more images corresponding to each product of the second one or more products, at the trained machine learning model;
compare the second one or more images corresponding to each product of the second one or more products, one product at a time, using one or more vectors from the trained machine learning model; and
analyze the second one or more images corresponding to each product of the second one or more products, one product at a time, based on the comparison of the second one or more images corresponding to each product of the second one or more products, using the trained machine learning model.

4. The machine learning based system of claim 3, wherein the trained machine learning model is configured to output the one or more vectors comprising one or more numerical values associated with the second one or more analyzed images corresponding to each product of the second one or more products.

5. The machine learning based system of claim 1, wherein in clustering, using the clustering model, the second one or more analyzed images in the one or more sets, the image clustering subsystem is configured to:
obtain the second one or more analyzed images corresponding to each product of the second one or more products, from the image analyzing subsystem;
compare each of the second one or more analyzed images with the second one or more analyzed images corresponding to each product of the second one or more products, one product at a time; and
cluster the second one or more analyzed images corresponding to each product of the second one or more products in the one or more sets, based on the comparison of each of the second one or more analyzed images with the second one or more analyzed images corresponding to each product of the one or more products, one product at a time,
wherein the one or more sets is created for the second one or more analyzed images corresponding to each product of the second one or more products,
wherein the compared second two or more analyzed images are corresponding to an analogical sub-product of the second one or more products,
wherein each set of the one or more sets is a sub-product cluster created for the second one or more analyzed images corresponding to the second one or more products, and
wherein the one or more sets is classified as at least one of:
the one or more sets created for the second one or more products, wherein the second one or more products comprises the two or more analogical sub-products with the analogical characteristics,
the one or more sets created for the second one or more products, wherein the second one or more products comprises the two or more analogical sub-products with the distinct characteristics, and
the one or more sets created for the second one or more products, wherein the second one or more products comprises the two or more distinct sub-products with the distinct characteristics.

6. The machine learning based system of claim 1, wherein the clustering model is a density-based spatial clustering of applications with noise (DBSCAN) model for clustering the second one or more analyzed images into the one or more sets.

7. The machine learning based system of claim 1, further comprising a product grouping subsystem configured to group one or more sub-product clusters created for the second one or more analyzed images corresponding to the second one or more products when second two or more products of second one or more sub-products are analogous.

8. The machine learning based system of claim 7, wherein upon grouping the one or more sub-product clusters, the product grouping subsystem is configured to perform one or more checks at cluster level to determine errors in data associated with the second one or more analyzed images corresponding to the second one or more products,
wherein performing the one or more checks comprises at least one of:
checking whether a first sub-product cluster needs to be left alone when the first sub-product cluster is created during analyzing of the second one or more images corresponding to each product of the second one or more products, the first sub-product cluster corresponds to;
checking whether the second one or more analyzed images corresponding to the first product of the second one or more products, in the first sub-product cluster, is merged with the second one or more analyzed images corresponding to the second product of the second one or more products when a correspondence between the first product and the second product is determined; and checking whether a second sub-product cluster created is at least one of: not a part of the second one or more products, and not a part of products other than the second one or more products.

9. A machine learning based method for optimizing one or more features of training datasets of one or more products, the machine learning based method comprising:
obtaining, by one or more hardware processors, a plurality of data associated with first one or more images corresponding to each product of first one or more products;
training, by the one or more hardware processors, a machine learning model based on the plurality of data associated with the first one or more images corresponding to each product of the first one or more products;
analyzing, by the one or more hardware processors, second one or more images corresponding to each product of second one or more products, one product at a time, using the trained machine learning model trained on the first one or more images corresponding to each product of the first one or more products;
clustering, by the one or more hardware processors, the second one or more analyzed images corresponding to each product of the second one or more products, one product at a time, using a clustering model;
creating, by the one or more hardware processors, one or more sets to obtain the clustered second one or more analyzed images corresponding to each product of the second one or more products,
wherein each set of the one or more sets comprises at least one second analyzed image corresponding to each product of the second one or more products,
wherein the one or more sets of the second one or more analyzed images corresponding to each product of the second one or more products, comprises at least one of: a first set of the second one or more analyzed images corresponding to a first product, a second set of the second one or more analyzed images corresponding to a second product, and an nth set of the second one or more analyzed images corresponding to an nth product,
wherein the first product, the second product, and the nth product are different products,
wherein when the second one or more analyzed images corresponding to each product of the second one or more products is clustered, the one or more sets is created for the second one or more products, and wherein the second one or more products comprises at least one of:
two or more analogical sub-products with analogical characteristics,
the two or more analogical sub-products with distinct characteristics, and
two or more distinct sub-products with distinct characteristics;
validating, by the one or more hardware processors, each set of the one or more sets created for the second one or more analyzed images corresponding to each product of the second one or more products to classify the one or more sets,
wherein the one or more sets is classified as at least one of:
the one or more sets created for the second one or more products, wherein the second one or more products comprises the two or more analogical sub-products with the analogical characteristics,
the one or more sets created for the second one or more products, wherein the second one or more products comprises the two or more analogical sub-products with the distinct characteristics, and
the one or more sets created for the second one or more products, wherein the second one or more products comprises the two or more distinct sub-products with the distinct characteristics; and
utilizing, by the one or more hardware processors, the clustered second one or more analyzed images for the training datasets for optimizing the one or more features of the training datasets, upon validation of each set of the one or more sets of the second one or more analyzed images corresponding to each product of the second one or more products.

10. The machine learning based method of claim 9, wherein training the machine learning model based on the plurality of data associated with the first one or more images corresponding to each product of the first one or more products, comprises:
receiving, by the one or more hardware processors, the plurality of data associated with the first one or more images corresponding to each product of the first one or more products;
providing, by the one or more hardware processors, a plurality of labels related to the first one or more images to the machine learning model, wherein the plurality of labels comprises of names of the first one or more products; and
training, by the one or more hardware processors, the machine learning model by correlating the first one or more images corresponding to each product of the first one or more products, with the plurality of labels related to the first one or more images, wherein the machine learning model is a supervised machine learning model.

11. The machine learning based method of claim 9, wherein analyzing, using the trained machine learning model, the second one or more images corresponding to each product of the second one or more products, comprises:
obtaining, by the one or more hardware processors, the second one or more images corresponding to each product of the second one or more products, at the trained machine learning model:
comparing, by the one or more hardware processors, the second one or more images corresponding to each product of the second one or more products, one product at a time, using one or more vectors from the trained machine learning model; and
analyzing, by the one or more hardware processors, the second one or more images corresponding to each product of the second one or more products, one product at a time, based on the comparison of the second one or more images corresponding to each product of the second one or more products, using the trained machine learning model.

12. The machine learning based method of claim 11, wherein the trained machine learning model is configured to output the one or more vectors comprising one or more numerical values associated with the second one or more analyzed images corresponding to each product of the second one or more products.

13. The machine learning based method of claim 9, wherein clustering, using the clustering model, the second one or more analyzed images in the one or more sets, comprises:
obtaining, by the one or more hardware processors, the second one or more analyzed images corresponding to each product of the second one or more products;
comparing, by the one or more hardware processors, each of the second one or more analyzed images with the second one or more analyzed images corresponding to each product of the second one or more products, one product at a time; and
clustering, by the one or more hardware processors, the second one or more analyzed images corresponding to each product of the second one or more products in the one or more sets, based on the comparison of each of the second one or more analyzed images with the second one or more analyzed images corresponding to each product of the second one or more products, one product at a time,
wherein the one or more sets is created for the second one or more analyzed images corresponding to each product of the second one or more products,
wherein the compared second two or more analyzed images are corresponding to a product of the second one or more products,
wherein each set of the one or more sets is a sub-product created for the second one or more analyzed images corresponding to the second one or more products, and
wherein the one or more sets is classified as at least one of:
the one or more sets created for the second one or more products, wherein the second one or more products comprises the two or more analogical sub-products with the analogical characteristics,
the one or more sets created for the second one or more products, wherein the second one or more products comprises the two or more analogical sub-products with the distinct characteristics, and
the one or more sets created for the second one or more products, wherein the second one or more products comprises the two or more distinct sub-products with the distinct characteristics.

14. The machine learning based method of claim 9, wherein the clustering model is a density-based spatial clustering of applications with noise (DBSCAN) model for clustering the second one or more analyzed images into the one or more sets.

15. The machine learning based method of claim 9, further comprising grouping, by the one or more hardware processors, one or more sub-product clusters created for the second one or more analyzed images corresponding to the second one or more products when second two or more products of second one or more sub-products are analogous.

16. The machine learning based method of claim 15, wherein upon grouping the one or more sub-product clusters, further comprising performing, by the one or more hardware processors, one or more checks at cluster level to determine errors in data associated with the second one or more analyzed images corresponding to the second one or more products, wherein performing the one or more checks comprises at least one of:
checking, by the one or more hardware processors, whether a first sub-product cluster needs to be left alone when the first sub-product cluster is created during analyzing of the second one or more images corresponding to each product of the second one or more products, the first sub-product cluster corresponds to:
checking, by the one or more hardware processors, whether the second one or more analyzed images corresponding to the first product of the second one or more products, in the first sub-product cluster, is merged with the second one or more analyzed images corresponding to the second product of the second one or more products when a correspondence between the first product and the second product is determined; and
checking, by the one or more hardware processors, whether a second sub-product cluster created is at least one of: not a part of the second one or more products, and not a part of products other than the second one or more products.

17. A non-transitory computer-readable storage medium having instructions stored therein that when executed by one or more hardware processors, cause the one or more hardware processors to execute operations of:
obtaining a plurality of data associated with first one or more images corresponding to each product of first one or more products;
training a machine learning model based on the plurality of data associated with the first one or more images corresponding to each product of the first one or more products;
analyzing second one or more images corresponding to each product of second one or more products, one product at a time, using the trained machine learning model trained on the first one or more images corresponding to each product of the first one or more products;
clustering the second one or more analyzed images corresponding to each product of the second one of more products, one product at a time, using a clustering model;
creating one or more sets to obtain the clustered second one or more analyzed images corresponding to each product of the second one or more products,
wherein each set of the one or more sets comprises at least one second analyzed image corresponding to each product of the second one or more products,
wherein the one or more sets of the second one or more analyzed images corresponding to each product of the second one or more products, comprises at least one of: a first set of the second one or more analyzed images corresponding to a first product, a second set of the second one or more analyzed images corresponding to a second product, and an nth set of the second one or more analyzed images corresponding to an nth product, and
wherein the first product, the second product, and nth product are different products,
wherein when the second one or more analyzed images corresponding to each product of the second one or more products is clustered, the one or more sets is created for the second one or more products, and wherein the second one or more products comprises at least one of:
two or more analogical sub-products with analogical characteristics,
the two or more analogical sub-products with distinct characteristics, and
two or more distinct sub-products with distinct characteristics;
validating each set of the one or more sets created for the second one or more analyzed images corresponding to each product of the second one or more products to classify the one or more sets.
wherein the one or more sets is classified as at least one of:
the one or more sets created for the second one or more products, wherein the second one or more products comprises the two or more analogical sub-products with the analogical characteristics,
the one or more sets created for the second one or more products, wherein the second one or more products comprises the two or more analogical sub-products with the distinct characteristics, and
the one or more sets created for the second one or more products, wherein the second one or more products comprises the two or more distinct sub-products with the distinct characteristics; and
utilizing the clustered second one or more analyzed images for the training datasets for optimizing the one or more features of the training datasets, upon validation of each set of the one or more sets of the second one or more analyzed images corresponding to each product of the second one or more products.

18. The non-transitory computer-readable storage medium of claim 17, wherein training the machine learning model based on the plurality of data associated with the first one or more images corresponding to each product of the first one or more products, comprises:
receiving the plurality of data associated with the first one or more images corresponding to each product of the first one or more products;
providing a plurality of labels related to the first one or more images to the machine learning model, wherein the plurality of labels comprises of names of the first one or more products; and
training the machine learning model by correlating the first one or more images corresponding to each product of the first one or more products, with the plurality of labels related to the first one or more images, wherein the machine learning model is a supervised machine learning model.

19. The non-transitory computer-readable storage medium of claim 17, wherein analyzing, using the trained machine learning model, the second one or more images corresponding to each product of the second one or more products, comprises:
obtaining the second one or more images corresponding to each product of the second one or more products, at the trained machine learning model;
comparing the second one or more images corresponding to each product of the second one or more products, one product at a time, using one or more vectors from the trained machine learning model; and
analyzing the second one or more images corresponding to each product of the second one or more products, based on the comparison of the second one or more images corresponding to each product of the second one or more products, one product at a time, using the trained machine learning model.

20. The non-transitory computer-readable storage medium of claim 19, wherein the trained machine learning model is configured to output the one or more vectors comprising one or more numerical values associated with the second one or more analyzed images corresponding to each product of the second one or more products.

21. The non-transitory computer-readable storage medium of claim 17, wherein clustering, using the clustering model, the second one or more analyzed images in the one or more sets, comprises:
obtaining the second one or more analyzed images corresponding to each product of the second one or more products;
comparing each of the second one or more analyzed images with the second one or more analyzed images corresponding to each product of the second one or more products, one product at a time; and
clustering the second one or more analyzed images corresponding to each product of the second one or more products in the one or more sets, one product at a time, based on the comparison of each of the second one or more analyzed images with the second one or more analyzed images corresponding to each product of the second one or more products,
wherein the one or more sets is created for the second one or more analyzed images corresponding to each product of the second one or more products,
wherein the compared second two or more analyzed images are corresponding to an analogical sub-product of the second one or more products,
wherein each set of the one or more sets is a sub-product created for the second one or more analyzed images corresponding to the second one or more products, and
wherein the one or more sets is classified as at least one of:
the one or more sets created for the second one or more products, wherein the second one or more products comprises the two or more analogical sub-products with the analogical characteristics,
the one or more sets created for the second one or more products, wherein the second one or more products comprises the two or more analogical sub-products with the distinct characteristics, and
the one or more sets created for the second one or more products, wherein the second one or more products comprises the two or more distinct sub-products with the distinct characteristics.

22. The non-transitory computer-readable storage medium of claim 17, wherein the clustering model is a density-based spatial clustering of applications with noise (DBSCAN) model for clustering the second one or more analyzed images into the one or more sets.

23. The non-transitory computer-readable storage medium of claim 17, further comprising grouping one or more sub-product clusters created for the second one or more analyzed images corresponding to the second one or more products when second two or more products of second one or more sub-products are analogous.

24. The non-transitory computer-readable storage medium of claim 23, wherein upon grouping the one or more sub-product clusters, further comprising performing one or more checks at cluster level to determine errors in data associated with the second one or more analyzed images corresponding to the second one or more products, wherein performing the one or more checks comprises at least one of:
checking whether a first sub-product cluster needs to be left alone when the first sub-product cluster is created during analyzing of the second one or more images corresponding to each product of the second one or more products, the first sub-product cluster corresponds to;
checking whether the second one or more analyzed images corresponding to the first product of the second one or more products, in the first sub-product cluster, is merged with the second one or more analyzed images corresponding to the second product of the second one or more products when a correspondence between the first product and the second product is determined; and
checking whether a second sub-product cluster created is at least one of: not a part of the second one or more products, and not a part of products other than the second one or more products.
